(19) United States
(12) Patent Application Publication
(10) Pub. No.: US 2013/0038119 A1
(43) Pub. Date: Feb. 14, 2013

(54) SEGMENTED SPROCKET ASSEMBLY SYSTEM

(71) Applicants: Trevor C. Griffith, Claypool, IN (US); Erich C. Griffith, Warsaw, IN (US)

(72) Inventors: Trevor C. Griffith, Claypool, IN (US); Erich C. Griffith, Warsaw, IN (US)

(21) Appl. No.: 13/536,485

(22) Filed: Jun. 28, 2012

Related U.S. Application Data
(60) Provisional application No. 61/525,040, filed on Aug. 18, 2011.
(60) Provisional application No. 61/522,818, filed on Aug. 12, 2011.

(51) Int. Cl. B62D 55/30; B23P 11/00

(52) U.S. Cl. 305/143; 29/525.01

(57) ABSTRACT

A sprocket assembly for a vehicle having a chassis and at least one endless track for engaging a ground surface. The track being movably coupled to the chassis and driven by the sprocket assembly. The sprocket assembly including at least one sprocket segment, a hub rotationally coupled to the chassis and a fastening system configured to displace some material portion of the sprocket segment when the sprocket segment is attached to the hub.

### CROSS REFERENCE TO RELATED APPLICATIONS

This is a non-provisional application based upon U.S. provisional patent application Ser. No. 61/525,040, entitled “TRACK TENSIONING SYSTEM”, filed Aug. 18, 2011, and U.S. provisional patent application Ser. No. 61/522,818, entitled “SEGMENTED SPROCKET ASSEMBLY”, filed Aug. 12, 2011, both of which are incorporated herein by reference.

### BACKGROUND OF THE INVENTION

1. Field of the Invention

The present invention relates to tracked vehicles, and, more particularly, to a segmented sprocket assembly method and system associated with the tracks of the vehicles.

2. Description of the Related Art

A crawler vehicle is typically has two endless tracks that serves to support and propel the vehicle. Each track is entrained about a drive sprocket, an idler roller and a series of track rollers. Typically the idler roller is adjustable to thereby alter the tension in the track to enable the track to function in a desired manner A tensioning mechanism is used to change the position of the idler roller to create the needed tension in the track so that the track is retained on the set of rollers. Wear in the track or stretching of the track creates slack in the track which needs to be removed for continued proper use of the track and this is accomplished by adjusting the tensioning mechanism.

Associated with each track is a drive sprocket that is powered by way of a gearing system that is driven by an engine. The drive sprockets typically have teeth that interact with the track to drive the track. The tensioning system, the power delivered through the gearing system and the resistance in moving the track against a load all contribute to forces that are transmitted through the drive sprocket. These forces provide stress on the connecting mechanism between the sprocket and a drive hub to which the sprocket is connected.

Drive sprockets may be segmented to provide for easier replacement. The sprocket may be composed of, for example, three segments that may be substantially similar. This would perhaps allow one of the segments to be disengaged from the track when it is rotated to a selected position, thereby allowing one segment at a time to be replaced without dismounting the track. Prior art systems have these segments bolted to the hub.

What is needed in the art is a way of attaching segmented gears in a more cost effective and secure manner than is currently available.

### SUMMARY OF THE INVENTION

The present invention provides an apparatus and method for mounting a drive sprocket to a hub of a tracked vehicle.

The invention in one form is directed to a sprocket assembly for a vehicle having a chassis and at least one endless track for engaging a ground surface. The track being movably coupled to the chassis and driven by the sprocket assembly. The sprocket assembly including at least one sprocket segment, a hub rotationally coupled to the chassis and a fastening system configured to displace some material portion of the sprocket segment when the sprocket segment is attached to the hub.

The invention in another form is directed to a method of securing a sprocket segment to a hub of a tracked vehicle, the method including the steps of orienting the sprocket segment relative to the hub; passing a fastener through the hub and the sprocket segment; and displacing some material of the sprocket segment with a fastening system.

An advantage of the present invention is that it the fastening system orients and secures the sprocket segment to the hub.

Another advantage is that the present invention allows for an interference fit between the connecting hardware and the sprocket segment.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematical side view of a tracked vehicle using a tensioning system according to the present invention;

FIG. 2 is a schematical view of the tensioning system used on the vehicle of FIG. 1;

FIG. 3 is an exploded perspective view of the drive sprocket used on the vehicle of FIG. 1; and

FIG. 4 is a partial sectional view of the sprocket of FIG. 3.

Corresponding reference characters indicate corresponding parts throughout the several views. The exemplifications set out herein illustrate one embodiment of the invention, and such exemplifications are not to be construed as limiting the scope of the invention in any manner.

### DETAILED DESCRIPTION OF THE INVENTION

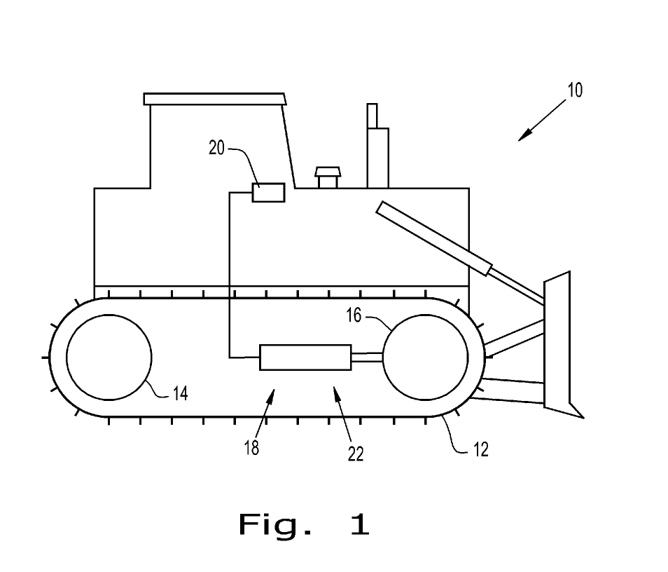

Referring now to the drawings, and more particularly to FIG. 1, there is shown in schematical form a side view of a tracked vehicle 10 having a track 12 driven by a toothed sprocket 14. Toothed sprocket 14 transfers rotational power from a power source (not shown) to track 12 thereby driving tracked vehicle 10 across the ground. An idler sprocket 16 is configured to tension track 12 by way of a tensioning system 18 that positions idler 16 such that excess slack in track 12 is removed. Additionally, when maintenance of the drive system is undertaken tensioning system 18 is used to back-off the tension on track 12 so that the drive components can be serviced. Toothed sprocket 14 is connected to a hub that is driven by way of a transmission and engine system. Toothed sprocket 14 may consist of one assembly or a series of segmented arcs that are arranged in a quasi-circular arrangement as they are connected to the hub.

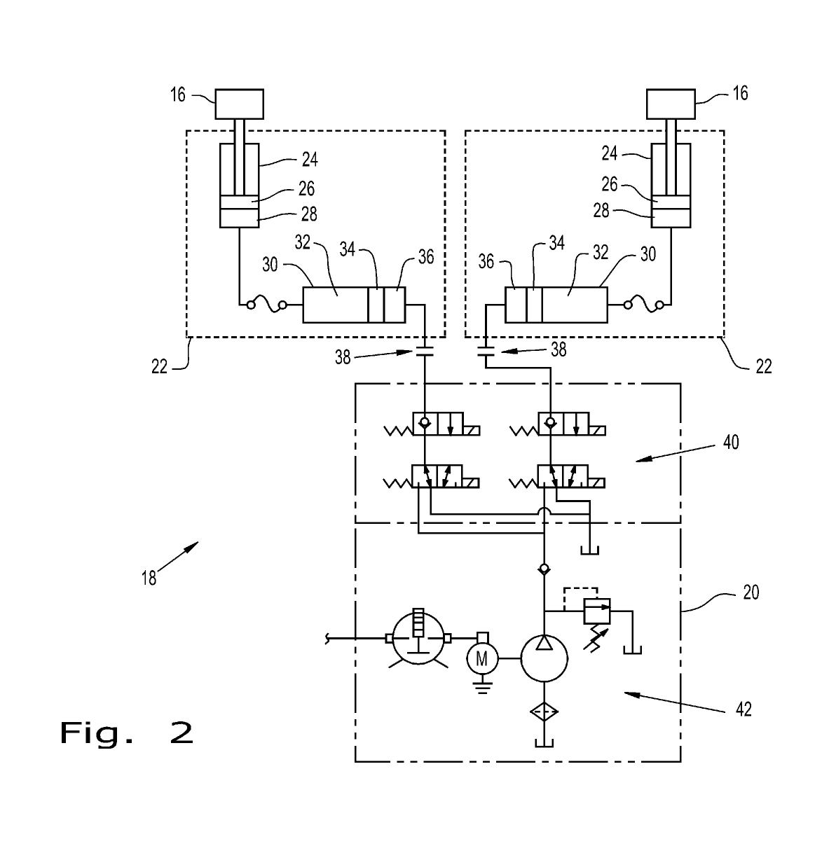

Now, additionally referring to FIG. 2, tensioning system 18 includes a control 20 and two tensioners 22, one for each of the tracks on tracked vehicle 10. Of course more tensioners 22 are contemplated for vehicles having additional tracks. Each tensioner 22 is shown schematically in FIG. 2 and includes tensioning cylinder 24 and pressurizing cylinder 30. Tensioning cylinder 24 has a rod that extends and retracts idler 16 as piston 26 moves dependent upon the amount of fluid 28 in cylinder 24. Fluid 28 is an incompressible fluid, and may be in the form of grease. Cylinder 30 is fluidly connected with cylinder 24, with fluid 32 being the same as fluid 28. Piston 34 is a floating piston, which separates fluid 32 from fluid 36. Fluid 36 may be a variety of fluids, such as air, nitrogen, oil or hydraulic fluid, which is kept separate from fluid 32. As the pressure in fluid 36 is varied it causes a displacement of fluids 28 and 32 to thereby reposition piston 26 and hence idler 16.

Cylinders 24 and 30 may be of one construct so that the cavities in which fluids 28 and 32 occupy are one cavity. There is a spring (not shown) associated with each idler 16 that allows tensioners 22 to retract when pressure is removed from fluid 36.

Valves 38 are illustrated as contacts or connections with the contacts being normally open which is the equivalent of indicating that the valves are normally closed thereby preventing the flow of fluid to/from tensioners 22. Valves 38 are only opened or used when there is a need to transfer fluid to/from the cavity where fluid 36 resides. Valves 38 can also be considered connections that automatically prevent the flow of fluid 36 when disconnected. This also illustrates a retrofit type of system of the present invention, where at least a part of control 20 is not part of tracked vehicle 10. For example on legacy equipment it may be desirous to temporarily connect control valves 40 with a hydraulic source 42, such as that already available on tracked vehicle 10, and connect valves 40 to the two tensioners 22. This allows legacy equipment to receive the benefits of the present invention, without the need to integrate an active and/or manual control system to vehicle 10. In this scenario adjustments to the tension of tracks 12 are made while tracked vehicle 10 is stationary. Alternatively, control 20 can be integrated as illustrated in FIG. 1 with new build or legacy equipment to thereby allow active adjustment of the tension of track 12.

As a further embodiment of the present invention, cylinders 30 may be disconnected from cylinders 24, such as a legacy cylinder on current equipment, at the point shown as a flexible connection in FIG. 2.

This also leads to another embodiment of a retrofit kit for legacy equipment with the addition of cylinders 30 to the legacy equipment to thereby utilize current grease cylinders 24 on tracked vehicle 10.

A substantial amount of torque is applied through sprocket assembly 14 and a problem encountered with the prior art toothed segments is the difficulty in aligning the segments and securing them in a manner to prevent movement and shifting of the segments once attached to the hubs.

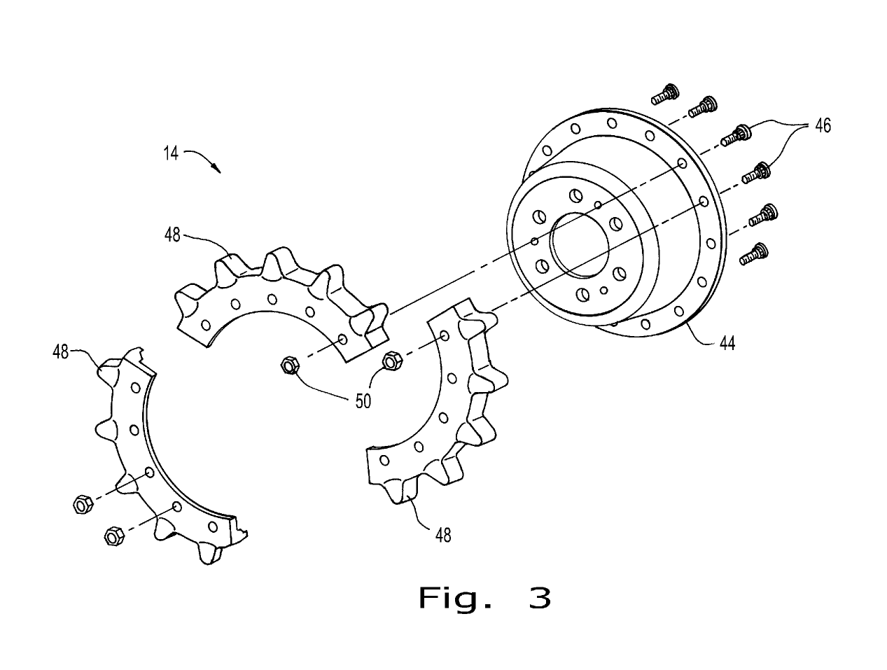

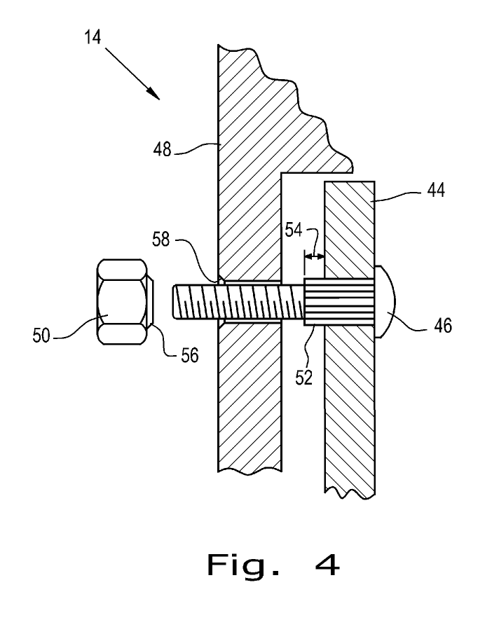

Now additionally referring to FIGS. 3 and 4, there is shown a toothed sprocket assembly 14 in an exploded form and in a cross-sectional form, having a hub 44 with splined studs 46, multiple toothed segments 48 and nuts 50. Splines 52 of splined studs 46 are arranged to extend through the thickness of hub 44 so that splines 52 additionally engage toothed segments 48. Splines 52 engage the edges of the holes in toothed segments 48 and may displace some of the metal of toothed segments 48 as toothed segments 48 are drawn tight against hub 44. Nuts 50 have a beveled extended surface that engages the hole in toothed segment 48, which may have a corresponding angled surface to cooperatingly interact with nut 50 to help align toothed segment 48 during installation.

As toothed segment 48 is being installed, splines 52 and the angled surfaces of nuts 50 and the holes in toothed segment 48 coact to align toothed segment 48 so that it is accurately positioned relative to hub 44 and thus to adjacent toothed segments 48. The present invention advantageously provides for the alignment of toothed segments 48 as they are installed and to tightly secured toothed segments 48 to hub 44 so that they will not shift as the substantial forces associated with tracked vehicle 10 are endured by toothed sprocket assembly 14 during the operation of tracked vehicle 10.

Toothed sprocket 14 is configured by the interaction of splines 52 with hub 16 and toothed segments 20 to withstand the tension applied to track 12 by tensioning system 18, as well as the forces applied during operation of the tracked vehicle. Although three segments 48 of sprocket 14 are illustrated other numbers of segments are also contemplated, including, but not limited to, 1, 2, 4, 5 and 6 segments. Also, although five splined studs 46 are illustrated as connecting each sprocket segment 48 to hub 44, other quantities are also contemplated and since the present invention is more effective at holding sprocket segments 48 to hub 44, fewer splined studs 46 may be needed than the bolt systems of the prior art. Advantageously the present invention may be easily adapted for use with legacy equipment with little or minimal modification of the hub and sprocket.

Splined studs 46 have a head, splines 52, and a threaded portion which nut 50 engages. The threaded portion is of a smaller diameter than the outer diameter of splines 52, allowing the threaded portion to easily pass through the corresponding holes in hub 44 and sprocket segment 48. As nut 50 is connected to the threaded portion of stud 46, tapered portion 56 engages the conical or beveled portion 58 of the hole through sprocket segment 48. This helps to orient and center sprocket segment 48 as it is being connected with hub 44. FIG. 4 illustrates that stud 46 is already connected to hub 44 and that splines 52 either have matched receiving grooves in hub 44 or that splines 52 have been forced into or drawn into hub 44. Hub 44 has a thickness at the point which stud 46 extends therethrough, and this thickness is less than the overall length of splines 52 along stud 46. Splines 52 extend beyond the surface of hub 44 by a distance 54. Distance 54 is sufficient to engage the material of sprocket segment 48 and displace some of the material as sprocket segment 48 is drawn to hub 44. It is also contemplated that distance 54 may approximate the thickness of sprocket segment 48, making allowance for taper 56.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A vehicle, comprising:
a chassis;
at least one endless track for engaging a ground surface, said at least one endless track being movably coupled to said chassis, said endless track having a tension; and
at least one sprocket assembly in contact with an inside portion of said endless track, said sprocket assembly including:
at least one hub rotationally coupled to said chassis;
at least one sprocket segment; and
a fastening system configured to displace some portion of material of said at least one sprocket segment when said sprocket segment is attached to said hub.

2. The vehicle of claim 1, wherein said at least one sprocket segment is a plurality of substantially similar sprocket segments.

3. The vehicle of claim 1, wherein said fastening system includes at least one stud extending through said hub and said at least one sprocket segment.

4. The vehicle of claim 3, wherein said stud has a plurality of radially extending protrusions.

5. The vehicle of claim 4, wherein said at least one hub has a thickness through which said stud extends, said radially extending protrusions extending along said stud a length, said length being greater than said thickness of said hub.

6. The vehicle of claim 5, wherein said radial extending protrusions are splines.

7. The vehicle of claim 6, wherein said fastening system further comprises a tapered nut, said stud having a threaded portion, said at least one sprocket segment having an internal conically shaped portion that interacts with said tapered nut and said splines to center a hole through said at least one sprocket segment about said stud.

8. The vehicle of claim 7, wherein said splines displace said material portion of said at least one sprocket segment as said tapered nut is tightened on said stud.

9. A sprocket assembly for a vehicle having a chassis, at least one endless track for engaging a ground surface, the at least one endless track being movably coupled to the chassis, the endless track being driven by the sprocket assembly, the sprocket assembly comprising:
at least one sprocket segment;
a hub rotationally coupled to the chassis; and
a fastening system configured to displace some material portion of said at least one sprocket segment when said sprocket segment is attached to said hub.

10. The sprocket assembly of claim 9, wherein said at least one sprocket segment is a plurality of substantially similar sprocket segments.

11. The sprocket assembly of claim 9, wherein said fastening system includes at least one stud extending through said hub and said at least one sprocket segment.

12. The sprocket assembly of claim 11, wherein said stud has a plurality of radially extending protrusions.

13. The sprocket assembly of claim 12, wherein said hub has a thickness through which said stud extends, said radially extending protrusions extending along said stud a length, said length being greater than said thickness of said hub.

14. The sprocket assembly of claim 13, wherein said radial extending protrusions are splines.

15. The sprocket assembly of claim 14, wherein said fastening system further comprises a tapered nut, said stud having a threaded portion, said at least one sprocket segment having an internal conically shaped portion that interacts with said tapered nut and said splines to center a hole through said at least one sprocket segment about said stud.

16. The sprocket assembly of claim 15, wherein said splines displace said material portion of said at least one sprocket segment as said tapered nut is tightened on said stud.

17. A method of securing a sprocket segment to a hub of a tracked vehicle, the method comprising the steps of:
orienting the sprocket segment relative to the hub;
passing a fastener through the hub and the sprocket segment; and
displacing some material of the sprocket segment with a fastening system.

18. The method of claim 17, wherein said fastening system includes at least one stud, said stud extending through said hub and through said at least one sprocket segment.

19. The method of claim 18, wherein said stud has a plurality of radially extending protrusions.

20. The method of claim 19, wherein said hub has a thickness through which said stud extends, said radially extending protrusions extending along said stud a length, said length being greater than said thickness of said hub.
